(19) United States
(12) Patent Application Publication
(10) Pub. No.: US 2014/0226374 A1
(43) Pub. Date: Aug. 14, 2014

(54) CTL CELL PROTECTION

(71) Applicants: Jürgen Häfneer, Ludvika (SE); Björn Jacobson, Gangesberg (SE)

(72) Inventors: Jürgen Häfneer, Ludvika (SE); Björn Jacobson, Gangesberg (SE)

(73) Assignee: ABB TECHNOLOGY AG, ZÜRICH (CH)

(21) Appl. No.: 14/235,736

(22) PCT Filed: Jul. 29, 2011
(86) PCT No.: PCT/EP2011/063089

§ 371 Date: Jan. 28, 2014

(51) Int. Cl. H02M 1/32

(52) U.S. Cl. CPC H02M 1/32
USPC 363/35

(57) ABSTRACT

A converter cell (110; 120) is provided. The converter cell comprises a capacitor (113; 123), a first (111; 121) and a second (112; 122) switching element connected in series, a first (114; 124) and a second (115; 125) connection terminal for connecting the converter cell to an external circuit, a bypass element (113; 123) connected in parallel to the capacitor, and a control unit (117). The control unit is arranged for closing, in response to detecting a condition which results in an uncontrolled charging of the capacitor, the bypass element. This is advantageous in that an uncontrolled charging of the cell capacitor, due to a failure of any one of the switching elements comprised in the converter cell, or a gate unit controlling the switching elements, may be prevented. Thereby, the risk for an over-voltage failure of the capacitor is mitigated. Further, a method of a converter cell is provided.

### FIELD OF THE INVENTION

The invention relates in general to high voltage direct current (HVDC) power transmission and distribution systems as well as flexible alternating current transmission systems (FACTS), and more specifically to voltage source converters (VSCs) and static var compensators based on series-connected converter cells.

### BACKGROUND OF THE INVENTION

In HVDC applications, multilevel converters based on multiple series-connected converter cells are frequently used for VSCs. In chain-link converters, e.g., the converter cells are typically of full-bridge type, whereas half-bridge type converter cells are preferred for cascaded two-level (CTL) converters.

A converter cell of half-bridge type comprises two switching elements and an energy storage element, such as a capacitor. At any time, each cell may provide a unipolar non-zero voltage contribution or no contribution, depending on the state of the switching elements, where only one of the switching elements may be switched on at a time.

A converter cell of full-bridge type comprises four switching elements and an energy storage element. Depending on the state of the switching elements, a bipolar non-zero voltage contribution of either polarity, or no contribution, may be provided.

The switching elements comprised in such converter cells are typically based on insulated gate bipolar transistors (IGBTs), or integrated gate commutated thyristors (IGCTs), and diodes which are connected anti-parallel to the transistors or thyristors, respectively.

In order to provide redundancy, converters cells based on series-connected press-pack IGBTs are frequently used. Due to the ruggedness of the press-pack modules, the converter cell can still be operated in the event of a failure of individual devices comprised in the press-pack.

However, in converters which are not based on series-connected IGBTs, a measure of protection of the converter cells in the event of a failure of one of the switching elements, or the gate unit controlling the switching elements, is desirable.

### SUMMARY OF THE INVENTION

It is an object of the present invention to provide a more efficient alternative to the above techniques and prior art.

More specifically, it is an object of the present invention to provide an improved protection of converter cells. It is a further object of the present invention to provide an improved protection of converter cells used in HVDC voltage source converters and FACTS static var compensators.

These and other objects of the present invention are achieved by means of a converter cell having the features defined in independent claim 1, and by means of a method of a converter cell defined in independent claim 11. Embodiments of the invention are characterized by the dependent claims.

According to a first aspect of the invention, a converter cell is provided. The converter cell comprises a capacitor, a first branch of switching elements, and a first and a second connection terminal. The first branch of switching elements is connected in parallel to the capacitor. The first branch of switching elements comprises a first and a second switching element. The first and the second switching element are connected in series. The first and the second connection terminal are arranged for connecting the converter cell to an external circuit. The converter cell further comprises a bypass element and controlling means. The bypass element is connected in parallel to the capacitor. The controlling means is arranged for closing the bypass element. The bypass element is closed in response to detecting a condition which results in an uncontrolled charging of the capacitor.

According to a second aspect of the invention, a method of a converter cell is provided. The converter cell comprises a capacitor, a first branch of switching elements, and a first and a second connection terminal. The first branch of switching elements is connected in parallel to the capacitor. The first branch of switching elements comprises a first and a second switching element. The first and the second switching element are connected in series. The first and the second connection terminal are arranged for connecting the converter cell to an external circuit. The method comprises closing the bypass element. The bypass element is closed in response to detecting a condition which results in an uncontrolled charging of the capacitor.

The present invention makes use of an understanding that an uncontrolled charging of the cell capacitor, due to a failure of one or several switching elements comprised in the converter cell, or a failure of the gate unit controlling the switching elements, may be prevented by providing a bypass element in parallel to the cell capacitor, i.e., on the direct current (DC) side of the converter cell. The bypass element is arranged for bypassing the cell capacitor in the event of a failure. The bypass element may be any type of auxiliary switch which is fast enough to interrupt an uncontrolled charging of the capacitor before a voltage level is reached which may compromise the integrity of the device and its surroundings. An embodiment of the invention is advantageous in that an over-voltage over the capacitor may be avoided, thereby mitigating the risk for an over-voltage failure of the capacitor.

According to an embodiment of the invention, the controlling means is further arranged for monitoring the first switching element, and closing the bypass element in response to detecting that the first switching element is in an uncontrollable open state. Monitoring the switching elements is advantageous in that an uncontrolled charging of the cell capacitor can be prevented. To this end, the first switching element being in an uncontrollable open state is the condition which results in an uncontrolled charging of the cell capacitor. Monitoring the switching elements is advantageous in that an uncontrolled charging may be prevented early by activating the bypass element.

According to an embodiment of the invention, the controlling means is further arranged for measuring a voltage over the capacitor and closing the bypass element in response to detecting that the measured voltage exceeds a predetermined threshold. In this embodiment, the condition which results in an uncontrolled charging of the cell capacitor is the voltage over the capacitor exceeding a predetermined limit. This is advantageous since the detected condition is directly related to the uncontrolled charging.

According to an embodiment of the invention, the first connection terminal is arranged for providing a connection to the junction between the first switching element and the capacitor. Further, the second connection terminal is arranged for providing a connection to the junction between the first and the second switching element. In other words, the circuit arrangement of the switching elements and the capacitor, and their connection to an external circuit, e.g., a converter, corresponds to the half-bridge type.

According to an embodiment of the invention, the converter cell further comprises a second branch of switching elements. The second branch of switching elements is connected in parallel to the capacitor. The second branch of switching elements comprises a third and a fourth switching element. The third and the fourth switching element are connected in series. The controlling means is further arranged for monitoring the first, the second, the third, and the fourth, switching element, and for closing the bypass element. The bypass element is closed in response to detecting that either the first switching element and the fourth switching element, or the second switching element and the third switching element, are in an uncontrollable open state. This is advantageous since the risk of an uncontrolled charging of the cell capacitor in a bipolar converter cell may be mitigated.

According to an embodiment of the invention, the first connection terminal is arranged for providing a connection to the junction between the first and the second switching element. Further, the second connection terminal is arranged for providing a connection to the junction between the third and the fourth switching element. This circuit arrangement of this embodiment of a converter cell corresponds to the full-bridge type.

According to an embodiment of the invention, each switching element comprises a bipolar transistor and a diode. The diode is connected anti-parallel to the transistor. For instance, the transistors may be IGBTs. Alternatively, any semiconductor switching device with turn-off capability, such as IGCTs, may be used. Preferably, the switching device and the diode are arranged in a press-pack housing.

According to an embodiment of the invention, the bypass element comprises a mechanical switch.

According to an embodiment of the invention, the bypass element further comprises a thyristor. The thyristor is connected in parallel to the mechanical switch. This is advantageous in that the thyristor may be used to quickly bypass the capacitor, whereas the mechanical switch provides a bypass in the event that the thyristors loses its gate signal, e.g., in the event of a gate unit failure, in particular if the gate unit is powered from the cell capacitor.

According to an embodiment of the invention, the converter cell further comprises means for reducing a current through the bypass element. This is advantageous in that the full short-circuit current of the capacitor, to which the bypass switch may be exposed, is limited. In that way, the current stress on the bypass element is reduced. If the converter cell comprises an inductive clamp, the reactor of the inductive clamp may be used for this purpose.

Further objectives of, features of, and advantages with, the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

The above, as well as additional objects, features and advantages of the present invention, will be better understood through the following illustrative and non-limiting detailed description of embodiments of the present invention, with reference to the appended drawings, in which:

FIG. 1 shows two half-bridge converter cells, in accordance with embodiments of the invention.

FIG. 2 shows a full-bridge converter cell, in accordance with an embodiment of the invention.

FIG. 3 shows a double-cell converter cell, in accordance with an embodiment of the invention.

FIG. 4 shows a half-bridge converter cell comprising an inductive clamp, in accordance with an embodiment of the invention.

All the figures are schematic, not necessarily to scale, and generally only show parts which are necessary in order to elucidate the invention, wherein other parts may be omitted or merely suggested.

### DETAILED DESCRIPTION

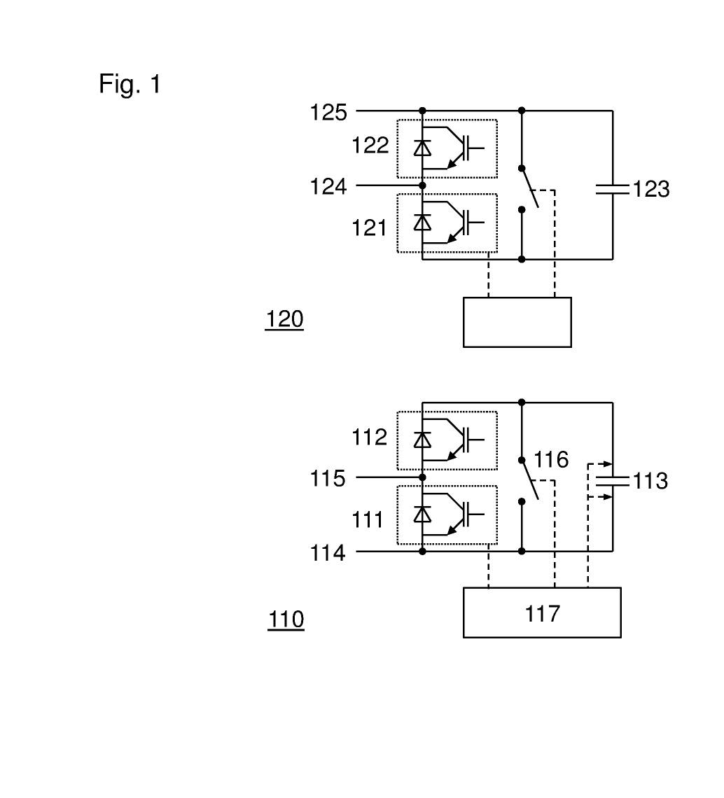

With reference to FIG. 1, a converter cell in accordance with an embodiment of the invention is described.

Converter cell 110 comprises two switching elements 111 and 112 connected in series, capacitor 113 connected in parallel to the series-connection of switching elements 111 and 112, connection terminals 114 and 115 for connecting converter cell 110 to an external circuit, and bypass element 116. Connection terminal 114 provides a connection to the junction between the first switching element 111 and capacitor 113, and connection terminal 115 provides a connection to the junction between the first 111 and the second 112 switching element.

Switching elements 111 and 112 of converter cell 110 are controlled by a control unit (not shown in FIG. 1), such as a gate unit, which is arranged for supplying gate signals to switching elements 111 and 112 so as to operate converter cell 110 as is known in the art. To this end, converter cell 110 is of half-bridge type, i.e., it is arranged for providing a unipolar voltage contribution via connection terminals 114 and 115. Converter cell 110 may, e.g., be part of a CTL converter

Bypass element 116 comprised in converter cell 110 is arranged for bypassing capacitor 113 in the event that switching element 111 remains in an open state, e.g., due to a failure of switching element 111 itself, or a failure of the gate unit. For this purpose, converter cell 110 is provided with control unit 117 which is arranged for monitoring switching element 111. In the event that an uncontrollable, i.e., permanent, open state is detected, control unit 117 activates bypass element 116, i.e., it closes the bypass. This may, e.g., be achieved by sending a trip signal to a mechanical switch, or by supplying a gate signal to a thyristor or a transistor, on which bypass element 116 is based.

Further with reference to FIG. 1, converter cell 110 may further be arranged for bypassing cell capacitor 113 in the event that a voltage over capacitor 113 exceeds a predetermined threshold. For this purpose, control unit 117 is further arranged for monitoring the voltage over capacitor 113 and for comparing the measured voltage to a voltage limit. In the event that an over-voltage is detected, control unit 117 activates bypass element 116.

An uncontrolled charging of cell capacitor 113 may occur in the event of a failure of switching element 111, or the gate unit controlling the switching elements. To this end, if switching element 111 is in an open state, a stable bypass is provided via the diode comprised in switching element 112 and bypass element 116. Typically, bypass element 116 should be activated within a few ms in order to prevent an uncontrolled charging of capacitor 113. In the event of switching element 112 being in an open state, on the other hand, an activation of bypass element 116 is not required, since switching element 111 is capable of controlling the cell voltage.

It will be appreciated by those skilled in the art that embodiments of the invention may be based on either the monitoring of the switching elements or the monitoring of the capacitor voltage alone, or on a combination of both.

Further with reference to FIG. 1, a second converter cell of half-bridge type, in accordance with another embodiment of the invention, is illustrated.

Converter cell 120 is similar to converter cell 110, and differs from the first only by the arrangement of connection terminals 124 and 125. More specifically, connection terminal 124 provides a connection to the junction between the first 121 and the second 122 switching element, and connection terminal 125 provides a connection to the junction between the second switching element 122 and capacitor 123. The different arrangements of connection terminals 114 and 115, as compared to 124 and 125, results in a different polarity of the non-zero voltage contribution provided by converter cells 110 and 120, respectively. For instance, if converter cell 110 is arranged for providing, via connection terminals 114 and 115, a non-zero voltage contribution of a first polarity, converter cell 120 is arranged for providing, via connection terminals 124 and 125, a non-zero voltage contribution of a second polarity which is opposite to the first polarity, and vice versa.

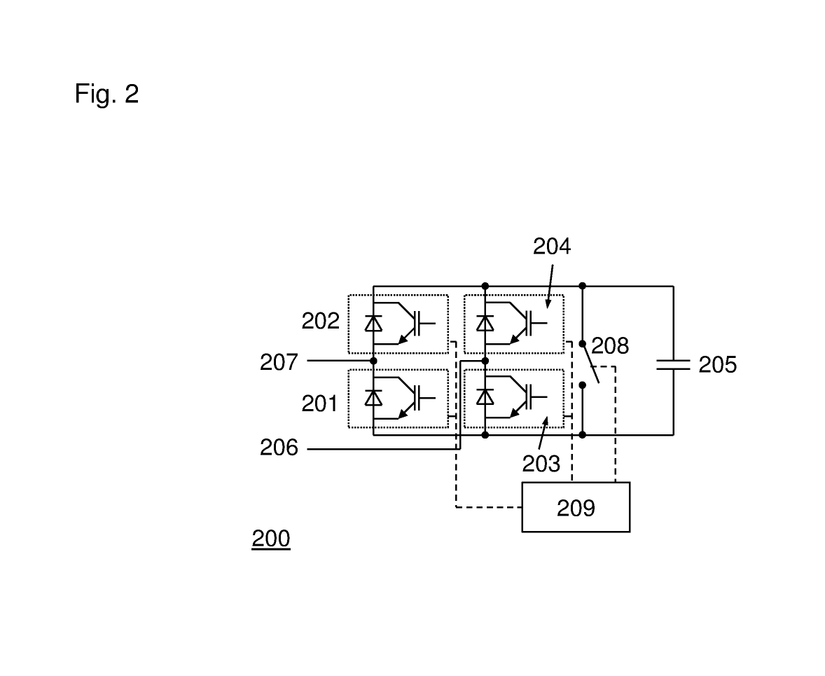

With reference to FIG. 2, a converter cell in accordance with another embodiment of the invention is described. Converter cell 200 comprises four switching elements 201-204, capacitor 205, connection terminals 206 and 207, and bypass element 208. Switching elements 201 and 202 are arranged in a first branch, and switching elements 203 and 204 are arranged in a second branch. Within each branch, the switching elements are connected in series, and the two branches are connected in parallel. Capacitor 205 and bypass element 208 are connected in parallel to the two branches of switching elements 201-204. The circuit arrangement of converter cell 200 is of full-bridge type, i.e., converter cell 200 is arranged for providing a bipolar voltage contribution via connection terminals 206 and 207. The polarity of the voltage contribution, and whether it is zero or non-zero, depends on the status of switching elements 201-204, as is known in the art, which status is controlled by a control unit (not shown in FIG. 2), e.g., a gate unit.

In analogy to converter cells 110 and 120 described with reference to FIG. 1, bypass element 208 comprised in converter cell 200 is arranged for bypassing capacitor 205 in the event that either both switching elements 201 and 204, or both switching elements 202 and 203, remain in an uncontrollable open state, e.g., due to a failure of the switching elements or the gate unit controlling the switching elements. For this purpose, converter cell 200 is provided with a control unit 209 which is arranged for monitoring switching elements 201-204. In the event that an uncontrollable, i.e., permanent open state is detected, control unit 209 activates bypass element 208, i.e., it closes the bypass. This may, e.g., be achieved by sending a trip signal to a mechanical switch, or by supplying a gate signal to a thyristor or a transistor, on which bypass element 208 is based.

For instance, if current is flowing through cell 200 from connection terminal 207 to connection terminal 206, the current may either flow via the transistor of switching element 201 and the diode of switching element 203, or via the diode of 202 and the transistor of switching element 204. Thus, if both switching elements 201 and 204 remain in an uncontrollable open state, bypass element 208 has to be activated, i.e., closed, in order to provide a bypass for the current via the diode of switching element 202, bypass element 208, and the diode of switching element 203.

For the opposite current direction, i.e., current flowing through cell 200 from connection terminal 206 to connection terminal 207, the current may either flow via the transistor of switching element 203 and the diode of switching element 201, or via the diode of 204 and the transistor of switching element 202. Thus, if both switching elements 201 and 204 remain in an uncontrollable open state, bypass element 208 has to be activated, i.e., closed, in order to provide a bypass for the current via the diode of switching element 204, bypass element 208, and the diode of switching element 201.

In other words, in order for converter cell 200 to be operable in a bipolar fashion, at least one switching element of each pair of switching elements 201/204 and 202/203 must be controllable.

Similar to what was described with reference to FIG. 1, control unit 209 may further be arranged for monitoring the voltage over capacitor 205, and for activating bypass element 208 in response to detecting an over-voltage over capacitor 205 (not shown in FIG. 2).

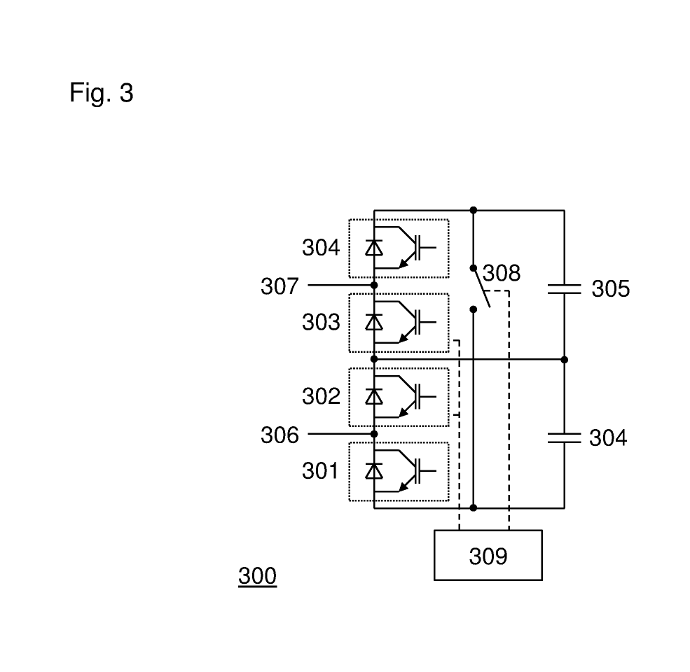

In FIG. 3, a converter cell according to another embodiment of the invention is shown.

Converter cell 300 comprises two sub-cells of half-bridge type, such as converter cells 110 and 120 discussed with reference to FIG. 1. The first converter cell comprises switching elements 301 and 302, and capacitor 304 connected in parallel to switching elements 301 and 302. The second sub-cell comprises switching elements 303 and 304, and capacitor 305 connected in parallel to switching elements 303 and 304. Further, converter cell 300 comprises connection terminals 306 and 307. Connection terminal 306 is arranged for providing a connection to the junction between the first 301 and the second 302 switching element of the first sub-cell, and connection terminal 307 is arranged for providing a connection to the junction between the first 303 and the second 304 switching element of the second sub-cell.

To this end, the sub-cells of converter cell 300 are interconnected so as to be able to provide a bipolar voltage contribution via connection terminals 306 and 307. More specifically, the first sub-cell, being similar to converter cell 120, and the second sub-cell, being similar to converter cell 110, are interconnected via connection terminals 125 and 114, respectively. Hence, connection terminal 306 corresponds to connection terminal 124 of concerter cell 120, and connection terminal 307 corresponds to connection terminal 115 of converter cell 110. The polarity of the voltage contribution, and whether it is zero or non-zero, depends on the status of switching elements 301-304, as is known in the art, which status is controlled by a control unit (not shown in FIG. 3), e.g., a gate unit.

However, contrary to a mere series connection of converter cells 110 and 120, converter cell 300 comprises a common bypass element 308, i.e., a bypass element which is connected in parallel to the series-connection of capacitors 304 and 305. Bypass element 308 is arranged for bypassing, in the event that any one of switching elements 302 or 303 remains in an open state, e.g., due to a failure of the switching element itself or the gate unit controlling the switching elements. For this purpose, converter cell 300 comprises control unit 309 which is arranged for monitoring switching elements 302 and 303. In the event that an uncontrollable, i.e., permanent open state is detected, control unit 309 activates bypass element 308.

It will also be appreciated that an embodiment of a double-cell converter cell, such as converter cell 300 discussed with reference to FIG. 3, may be envisaged which comprises two bypass element, i.e., one for each cell capacitor. In this case, a control unit which the converter cell is provided with may be arranged for detecting an uncontrollable open state of either switching element 302 or 303 and for activating the corresponding bypass element. Alternatively, the control unit may also be arranged for activating both bypass elements in the event of a failure of one of the switching elements 302 and 303.

Similar to what was described with reference to FIG. 1, control unit 309 may further be arranged for monitoring the voltages over capacitors 304 and 305, respectively, and for activating bypass element 308 in response to detecting an over-voltage over either one of the capacitors or both capacitors (not shown in FIG. 3).

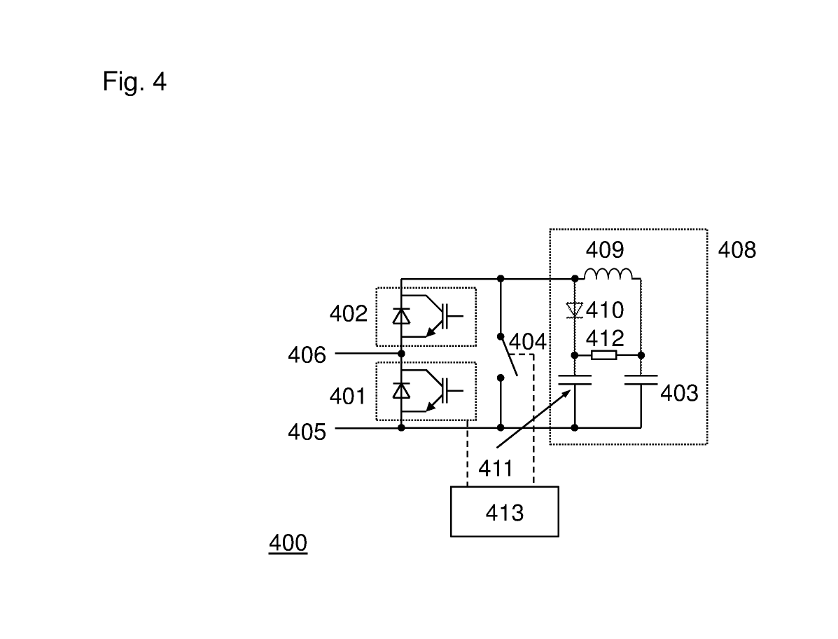

A further embodiment of the invention is illustrated in FIG. 4.

Converter cell 400 is of half-bridge type, similar to converter cell 110 described hereinbefore, and comprises two switching elements 401 and 402, cell capacitor 403, bypass element 404, connection terminals 405 and 406, and a control unit (not shown in FIG. 4). Converter cell 400 differs from converter cell 110 in that it further comprises an inductive clamp 408 connected in parallel to the series-connection of switching elements 401 and 402. Inductive clamp 408 comprises reactor 409, diode 410, clamp capacitor 411, and resistor 412. Cell capacitor 403 is also part of the circuit of inductive clamp 408. Further, converter cell 400 comprises control unit 413 which is arranged for monitoring switching element 401 and for activating, in response to detecting an uncontrollable open state of switching element 401, bypass element 404.

In the event of an activation of bypass element 404 in response to the determination of an uncontrollable open state by control unit 413, reactor 409 comprised in inductive clamp 408 reduces the current flowing from cell capacitor 403 through bypass element 404, thereby reducing the current stress on bypass element 404.

A further advantage of inductive clamp 408 is that resistor 412 may be used for a fast discharge of cell capacitor 403, e.g., during a planned stop or an emergency shutdown. For this purpose, inductive clamp 408 may be provided with a further switch.

Similar to what was described with reference to FIG. 1, control unit 413 may further be arranged for monitoring the respective voltages over capacitor 403 and for activating bypass element 404 in response to detecting an over-voltage (not shown in FIG. 4).

The person skilled in the art realizes that the present invention by no means is limited to the embodiments described above. On the contrary, many modifications and variations are possible within the scope of the appended claims. For example, instead of providing a converter cell in accordance with an embodiment of the invention with an inductive clamp, as described hereinabove, one may envisage embodiments of the invention comprising other means for reducing the current through the bypass element, such as a reactor connected in series with the bypass element. Further, it will also be appreciated by those skilled in the art that the unit for controlling the bypass element and a gate unit for controlling the switching elements may be combined into one unit.

In conclusion, a converter cell is provided. The converter cell comprises a capacitor, a first and a second switching element connected in series, a first and a second connection terminal for connecting the converter cell to an external circuit, a bypass element connected in parallel to the capacitor, and a control unit. The control unit is arranged for closing, in response to detecting a condition which results in an uncontrolled charging of the capacitor, the bypass element. This is advantageous in that an uncontrolled charging of the cell capacitor, due to a failure of any one of the switching elements comprised in the converter cell, or a gate unit controlling the switching elements, may be prevented. Thereby, the risk for an over-voltage failure of the capacitor is mitigated. Further, a method of a converter cell is provided.

1-10. (canceled)

11. A converter cell of a high voltage direct current voltage source converter or a flexible alternating current transmission system static var compensator comprising:
a capacitor,
a first branch of switching elements connected in parallel to the capacitor, the first branch comprising a first and a second switching element connected in series, and a first and a second connection terminal being arranged for connecting the converter cell to an external circuit, wherein the converter cell further comprises:
a bypass element connected in parallel to the capacitor, and
controlling means being arranged for:
monitoring the first switching element, and
closing the bypass element in response to detecting that the first switching element is in an uncontrollable open state.

12. The converter cell according to claim 11, wherein the first connection terminal is arranged for providing a connection to the junction between the first switching element and the capacitor, and the second connection terminal is arranged for providing a connection to the junction between the first and the second switching element.

13. The converter cell according to claim 11, further comprising: a second branch of switching elements connected in parallel to the capacitor, the second branch comprising a third and a fourth switching element connected in series,
and wherein the controlling means is further arranged for:
monitoring the first, the second, the third, and the fourth, switching element, and
closing, in response to detecting that either the first switching element and the fourth switching element, or the second switching element and the third switching element, are in an uncontrollable open state, the bypass element.

14. The converter cell according to claim 13, wherein the first connection terminal is arranged for providing a connection to the junction between the first and the second switching element, and the second connection terminal is arranged for providing a connection to the junction between the third and the fourth switching element.

15. The converter cell according to claim 11, wherein each switching element comprises a bipolar transistor and a diode connected anti-parallel to the transistor.

16. The converter cell according to claim 11, wherein the bypass element comprises a mechanical switch.

17. The converter cell according to claim 16, wherein the bypass element further comprises a thyristor connected in parallel to the mechanical switch.

18. The converter cell according to claim 11, further comprising means for reducing a current through the bypass element.

19. A method in a converter cell of a high voltage direct current voltage source converter or a flexible alternating current transmission system static var compensator comprising: a capacitor,
a first branch of switching elements connected in parallel to the capacitor, the first branch comprising a first and a second switching element connected in series, and
a first and a second connection terminal being arranged for connecting the converter cell to an external circuit,
wherein the method comprises:
monitoring the first switching element, and
closing the bypass element in response to detecting that the first switching element is in an uncontrollable open state.

20. The method according to claim 19, wherein the converter cell further comprises:
a second branch of switching elements connected in parallel to the capacitor, the second branch comprising a third and a fourth switching element connected in series, and wherein the method further comprises: monitoring the first, the second, the third, and the fourth, switching element, and
closing, in response to detecting that either the first switching element and the fourth switching element, or the second switching element and the third switching element, are in an uncontrollable open state, the bypass element.

21. The converter cell according to claim 12, wherein each switching element comprises a bipolar transistor and a diode connected anti-parallel to the transistor.

22. The converter cell according to claim 13, wherein each switching element comprises a bipolar transistor and a diode connected anti-parallel to the transistor.

23. The converter cell according to claim 14, wherein each switching element comprises a bipolar transistor and a diode connected anti-parallel to the transistor.
